(19) United States
(12) Patent Application Publication
(10) Pub. No.: US 2006/0176657 A1
(43) Pub. Date: Aug. 10, 2006

(54) Fastener for an adapter in a laptop computer

(76) Inventor: Huang-Chou Huang, Taipei Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/055,660

(22) Filed: Feb. 8, 2005

(51) Int. Cl. G06F 1/16

(52) U.S. Cl. 361/683

(57) ABSTRACT

A fastener for an adapter of a laptop computer includes a lateral portion and an upright portion. The lateral portion has a finger formed at an approximate end of the lateral portion. A seat is formed at a distal end of the lateral portion and two ears are formed at two opposed ends of the seat and extend upward. The upright portion is integrally formed on the lateral portion and perpendicular to the lateral portion. The upright portion has an extending part extending between the ears of the U-like seat. A hook is formed at a distal end of the extending part. Whereby, the extending part and an arm of the adapter are blocked by the ears and cannot be bent excessively whereby the arm is prevented from being broken.

### BACKGROUND OF THE INVENTION

1. Field of the Invention

The present invention relates to a fastener for an adapter in a laptop computer, and more particularly to a fastener which can prevent arms of the adapter being excessively bent and thereby breaking.

2. Description of Related Art

A conventional desktop computer generally comprises a chassis, a display, a mouse, a keyboard etc. Therefore, it is inconvenient to carry the conventional desktop computer due to its large volume. Hence, laptop computers with compact and integrated structure are developed for being carried conveniently, wherein notebook computers are typical of the trend.

In the notebook computers, electrical components such as a RAM (Read Only Memory) are first installed in an adapter, and the adapter along with the electrical component is then installed in the notebook computer.

With reference to FIG. 6, the conventional adapter includes a socket (20) and two arms (21) respectively formed at two opposed ends of the socket (20). A hole (211) is defined in the interior of each arm (21). With the reference to FIGS. 6 and 7, two fasteners (30), respectively mounted on the arms (21), each comprise an upright portion (31) and a lateral portion (32) perpendicular to and connected to the upright portion (31). A hook (311) is formed on a distal end of the upright portion (31) away from the socket (20), and a supporting part (312) parallel to the lateral portion (32) is formed at a bottom side of the distal end of the upright portion (31). A finger (322) integrally formed on an approximate end of the lateral portion (32) adjacent to the socket (20) can be inserted into the hole (211). An S-like lug (321) is integrally formed on a side of the lateral portion (32) opposed to the upright portion (31).

After the electrical component is received in the socket (20), the finger (322) is inserted in the hole (211) and the hooks (311) can be securely connected to a free end of the respective arm (21), so the electrical component is fastened in the adapter. Then, the socket (20) along with the electrical component is pushed into and securely mounted in the notebook computer. However, during the installation of the adapter in the computer, the arms (21) may be pressed to bend inwards or outwards. If bent improperly, the arms (21) may be broken.

Therefore, the invention provides a fastener for an adapter of a laptop computer to mitigate or obviate the aforementioned problems.

### SUMMARY OF THE INVENTION

The main objective of the present invention is to provide a fastener for an adapter of a laptop computer which can prevent arms of the adapter from being bent excessively.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a fastener for an adapter of a laptop computer in accordance with the present invention;

FIG. 2 is a top view of the fastener in accordance with the present invention;

FIG. 3 is a perspective view of the fasteners of the invention separate from an adapter;

FIG. 4 is a perspective view of the fasteners of the invention connected to the adapter;

FIG. 5 is a partially sectional view of the fastener connected to the adapter;

FIG. 6 is a perspective view of a conventional fastener for an adapter of a laptop computer and the adapter; and

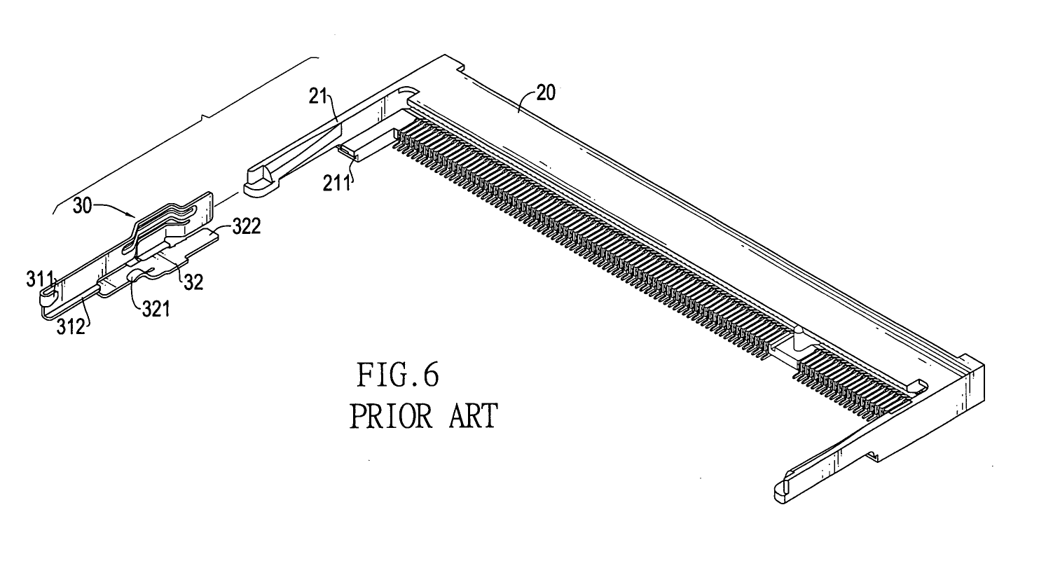

FIG. 7 is a perspective view of the conventional fastener.

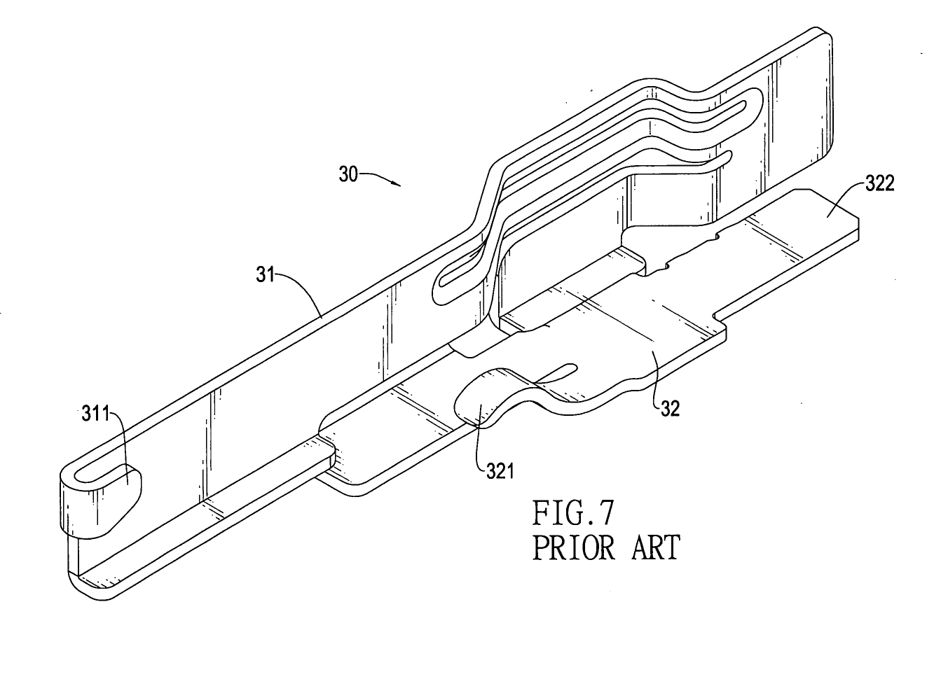

### DETAILED DESCRIPTION OF THE PREFERRED EMBODIMENT

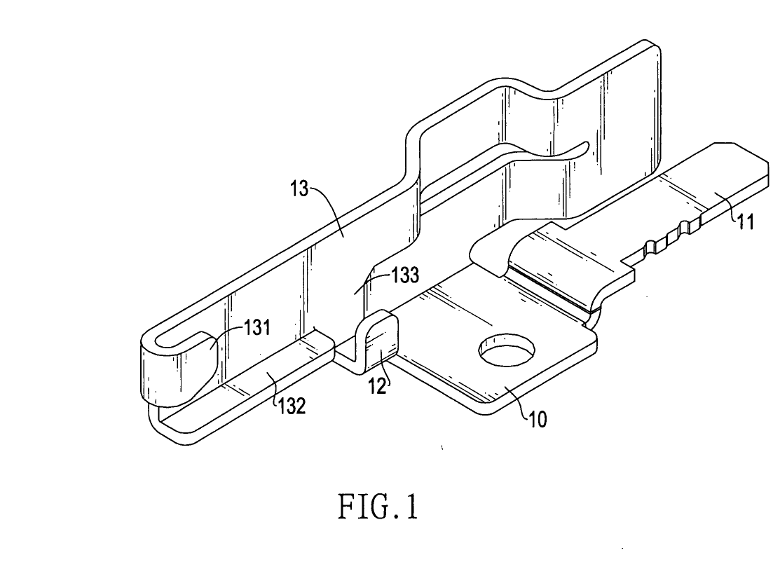

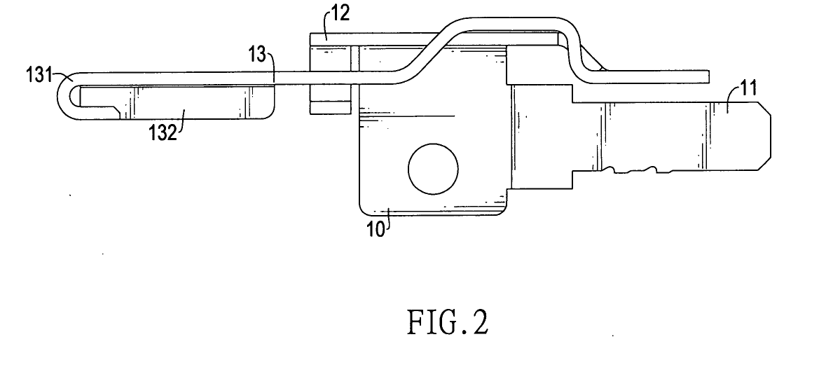

With reference to FIGS. 1-2, according to the present invention, a fastener for an adapter of a laptop computer, with an L-like cross section, is composed of a lateral portion (10) and an upright portion (13).

The lateral portion (10) has a finger (11) formed at an approximate end and a U-like seat (12) formed at a distal end. The U-like seat (12) has two ears formed at two opposed ends thereof.

The upright portion (13) is integrally formed on the lateral portion (10) and perpendicular to the lateral portion (10). The upright portion (13) has an extending part (133) extending between the ears of the U-like seat (12). A hook (131) is formed on a distal end of the extending part ( 133). A supporting part (132) is formed at a bottom side of the distal end of the extending part (133) and substantially parallel to the lateral portion (10).

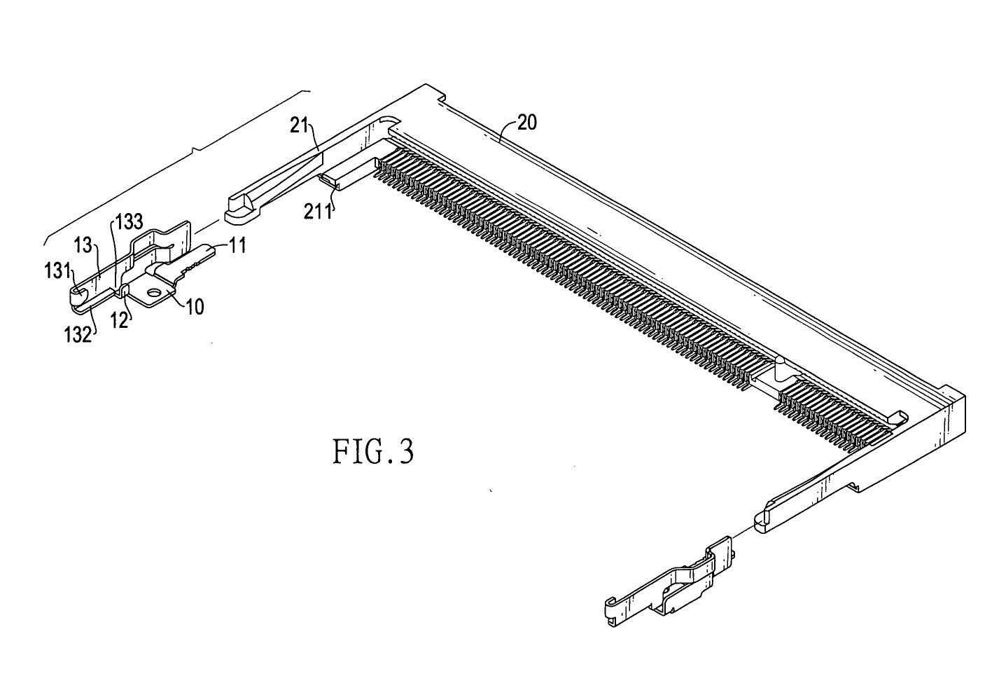

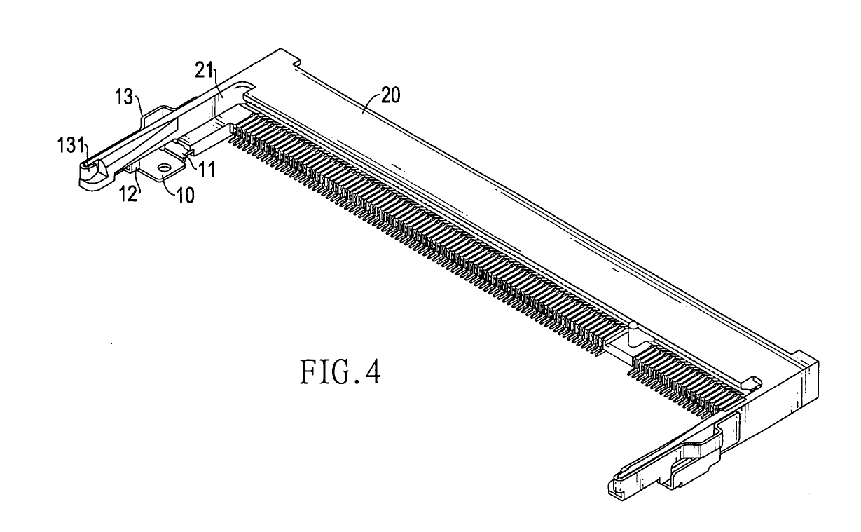

With reference to FIGS. 3-4, the adapter has the same structure as the conventional adapter. After an electrical component is inserted in the socket (20), the fastener is installed on the respective arm (21). The finger (11) is inserted in the respective hole (211), and the hook (131) is attached to the free end of the arm (21). The supporting part (132) abuts a bottom face of the arm (21) to support the arm (21), and the arm (21) extends between the ears of the U-like seat (12).

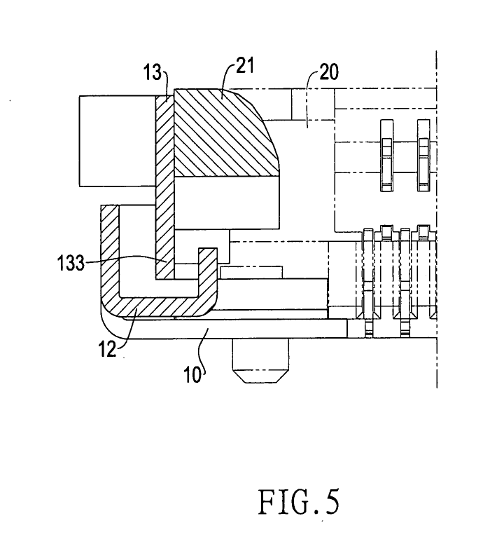

With reference to FIG. 5, when the adapter is inserted into the laptop computer, the arms (21) and the upright portion (13) may be bent transversally by a user. By being blocked by the ears, the extending part (133) and the arm (21) cannot be bent excessively and thus the arm (21) is prevented from being broken.

Therefore, by using the fastener of the present invention, the arms (21) of the adapter cannot be bent excessively and are protected.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastener for an adapter of a laptop computer comprising:
a lateral portion (10) having a finger (11) formed at an approximate end of the lateral portion (10), and a U-like seat (12) formed at a distal end of the lateral portion (10) and with two ears formed at two opposed ends of the U-like seat (12) and extending upwards; and
an upright portion (13) integrally formed on the lateral portion (10) and perpendicular to the lateral portion (10), the upright portion (13) having an extending part (133) extending between the ears of the U-like seat (12), and a hook (131) formed at a distal end of the extending part (133).

2. The fastener as claimed in claim 1, wherein the upright portion (13) further comprises a supporting part (132) formed at a bottom side of the distal end of the extending part (133) and parallel to the lateral portion (10).
